(19) United States
(12) Patent Application Publication
(10) Pub. No.: US 2020/0253424 A1
(43) Pub. Date: Aug. 13, 2020

(54) Food Processor With Spiralizing Accessory

(71) Applicant: Hamilton Beach Brands, Inc., Glen Allen, VA (US)

(72) Inventor: Benjamin H Branson, III, Mechanicsville, VA (US)

(21) Appl. No.: 16/275,098

(22) Filed: Feb. 13, 2019

(51) Int. Cl. A47J 43/07; A47J 43/046

(52) U.S. Cl. CPC A47J 43/0722; A47J 2043/0738; A47J 43/046

(57) ABSTRACT

A food processor includes: a base having a motor mounted therein; a container mounted on the base; a drive train that is coupled to the motor and extends into the container; a lid that overlies the container, the lid including a generally horizontal upper surface and a food chute that feeds into the container, the food chute extending both above and below the upper surface of the lid; and a spiralizer accessory. The spiralizer accessory includes a base that mounts on the container and a spiralizer member having a spiralizing blade, the spiralizer cone residing in a recess in the base and engaging the drive train, such that rotation of the drive train rotates the spiralizer member. An upper edge of the spiralizer member extends into the food chute.

### FIELD OF THE INVENTION

The present invention is directed to processing foodstuffs and, more particularly, to a food processor with spiralizing capability.

### BACKGROUND

Food processors or other such appliances have become popular and are commonly used in residential and/or commercial kitchens or other locations where foodstuff is prepared. A typical food processor includes a container, a lid with a food chute extending generally perpendicularly from the top surface of the lid, a food pusher that can extend within the food chute to force food into the container, a processing disc, and a rotary blade. Ordinarily the container is mounted onto a motor base, and one or more buttons in the motor base allow a user to actuate the electric motor to rotate the blades.

In addition, some food processors include other functionality. For example, some food processors may include a “spiralizing” disk that allows certain foods, such as carrots, cucumbers, and other fruits and vegetables, to be formed into a “spiral” arrangement. The spiralizing disk may have a conical profile (with the narrower end extending downward into the container) that encourages the food to be positioned toward the center of the disk for proper spiralizing.

Because of the overall configuration of the lid and because of the length of the food chute, it is often difficult to store all of the components of the food processor in an efficient and compact manner. For example, many consumers typically store the rotary blade and container together and separately store the lid, the food pusher and any other disks together. Thus, storage of the food processor generally takes up much space in the consumer's drawers, cabinets, etc. Spiralizing disks typically require an additional food pusher for optimal operation, which add one additional (and relatively large) component that must be stored.

In view of the foregoing, it may be desirable to provide improved food processor configurations that can provide desired functions while minimizing storage space.

### SUMMARY OF THE INVENTION

As a first aspect, embodiments of the invention are directed to a food processor, comprising: a base having a motor mounted therein; a container mounted on the base; a drive train that is coupled to the motor and extends into the container; a lid that overlies the container, the lid including a generally horizontal upper surface and a food chute that feeds into the container, the food chute extending both above and below the upper surface of the lid; and a spiralizer accessory. The spiralizer accessory includes a base that mounts on the container and a rotary spiralizer member having a spiralizing blade, the spiralizer member residing in a recess in the base and engaging the drive train, such that rotation of the drive train rotates the spiralizer member. An upper edge of the spiralizer member extends into the food chute.

As a second aspect, embodiments of the invention are directed to a food processor, comprising: a base having a motor mounted therein; a container mounted on the base; a drive train that is coupled to the motor and extends into the container; a lid that overlies the container, the lid including a generally horizontal upper surface and a food chute that feeds into the container; and a spiralizer accessory. The spiralizer accessory includes a base that mounts on the container and a spiralizer member having a spiralizing blade, the spiralizer member residing in a recess in the base and engaging the drive train, such that rotation of the drive train rotates the spiralizer member. The drive train includes a toothed portion adjacent its upper end, and the spiralizer member includes a plurality of teeth on a peripheral edge thereof that engage the toothed portion of the drive train. An upper edge of the spiralizer member extends above the toothed portion of the drive train.

As a third aspect, embodiments of the invention are directed to a food processor, comprising: a base having a motor mounted therein; a container mounted on the base; a drive train that is coupled to the motor and extends into the container; a lid that overlies the container, the lid including a generally horizontal upper surface and a food chute that feeds into the container; and a spiralizer accessory. The spiralizer accessory includes a base with a horizontal upper surface that mounts on the container and a spiralizer cone having a conical surface and a spiralizing blade, the spiralizer cone residing in a recess in the horizontal surface of the base and engaging the drive train, such that rotation of the drive train rotates the spiralizer cone. An upper edge of the spiralizer cone extends above the upper surface of the spiralizer accessory base and a lowermost end of the spiralizer cone extends below the upper surface of the spiralizer accessory base.

### BRIEF DESCRIPTION OF THE FIGURES

FIG. 1 is a perspective view of a food processor according to embodiments of the invention.

FIG. 2 is a perspective view of a storage case for additional accessories for the food processor of FIG. 1.

FIG. 3 is a section view of the food processor of FIG. 1.

FIG. 4 is a section view of the bowl of the food processor of FIG. 1.

FIG. 5 is a top perspective view of the lid of the food processor of FIG. 1.

FIG. 6 is a bottom perspective view of the lid of FIG. 5.

FIG. 7A is a top perspective view of the food processor of FIG. 1 in phantom line with a spiralizer accessory in place and the lid removed.

FIG. 7B is a reverse top perspective view of the food processor of FIG. 1.

FIG. 8 is a side perspective view of the spiralizer accessory of FIG. 7A.

FIG. 9 is a partial top perspective section view of the spiralizer accessory and drive train of the food processor of FIG. 1.

FIG. 10 is a top perspective view of the spiralizer accessory of FIG. 9 with the lid shown in phantom line.

FIG. 11 is a top side perspective view of the spiralizer accessory of FIG. 9 and the food pusher with the lid shown in phantom line.

FIG. 12 is a partial perspective section view of the spiralizer accessory and drive train of the food processor of FIG. 1.

FIG. 13A is a perspective view of a typical dough blade for the food processor of FIG. 1.

FIG. 13B is a perspective view of a typical S-blade for the food processor of FIG. 1.

FIG. 14 is a perspective view of a typical shredder disk for the food processor of FIG. 1.

FIG. 15A is a top perspective view of a typical slicing disk for the food processor of FIG. 1.

FIG. 15B is a bottom perspective view of the slicing disk of FIG. 15A.

FIG. 16 is a perspective view of the food pusher to be used with the food processor of FIG. 1.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the figures, certain layers, components or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Referring now to the figures, a food processor, designated broadly at 20, is shown in FIG. 1. The food processer 20 includes a base 22, a bowl 24, a lid 26, and a drive train 28 attached to a motor 30 that drives the various blades and accessories that can be used with the food processor 20. These components are described in greater detail below.

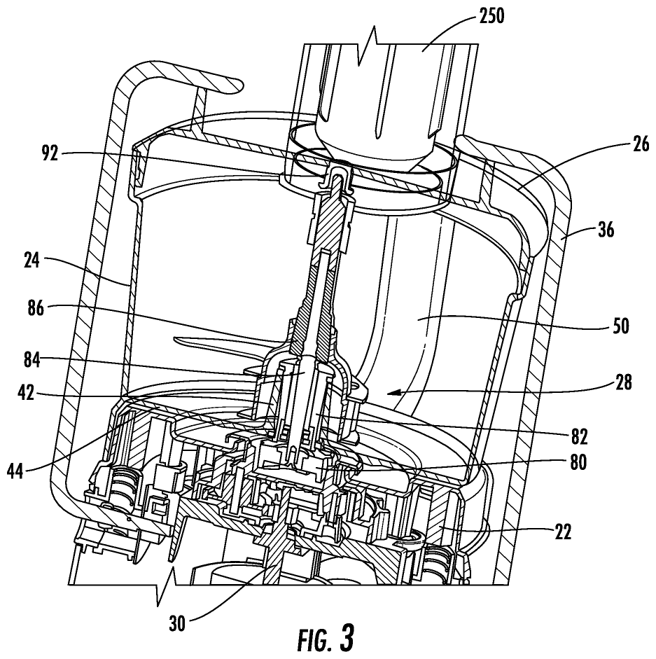

The base 22 provides a foundation for the food processor 20. The motor 30 is housed within the base 22 (see FIG. 3) and can be controlled by a dial 32 and one or more actuation switches 34. The motor 30 is coupled to the drive train 28, which extends upwardly from the upper surface of the base 22. A bale lock 36 is pivotally attached to side walls of the base 22 and can pivot to a vertical position in which it maintains the lid 26 in place.

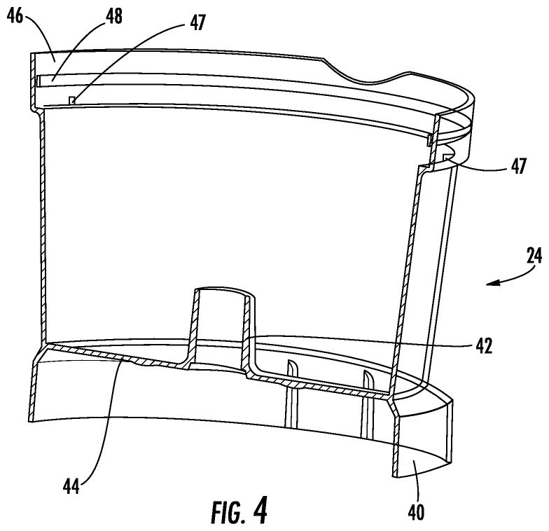

Referring now to FIGS. 3 and 4, the bowl 24 is generally cylindrical and rests atop the base 22. The bowl 24 includes a lower skirt 40 that overlies the upper outer edge of the base 22. The skirt 40 may be sized to snugly fit on the base 22, and/or may include snaps, latches, or the like to enhance the stability of the fit. A boss 42 extends upwardly from the lower surface 44 of the bowl 24. The drive train 28 extends upwardly from the base 22 and through the boss 42. At its upper end, the bowl 24 has a radially-expanded lip 46 with an inwardly-extending ridge 48. Multiple nubs 47 are located on the lower surface of the lip 46 to assist with proper positioning/registration of accessories. Also, a handle 50 extends radially outwardly from one side of the bowl 24. A handle 50 (FIG. 1) extends from one side to facilitate handling.

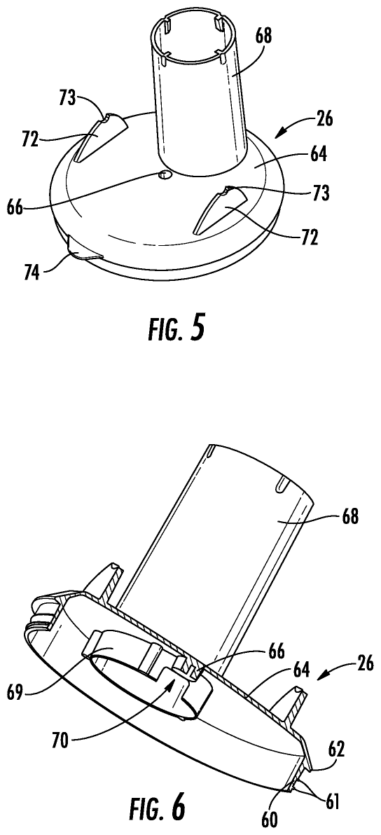

Referring now to FIGS. 5 and 6, the lid 26 has a lower rim 60 with two outwardly-extending lips 61. The lips 61 capture the ridge 48 of the lip 46 of the bowl 24 to maintain the lid 26 in place on the bowl 24, with the rim 60 radially inward of the lip 46. A shoulder 62 extends outwardly from the upper edge of the rim 60. The lid 26 also has a generally horizontal upper surface 64. A locater boss 66 extends downwardly from the center of the upper surface 64. A hollow, cylindrical food chute 68 extends upwardly from the upper surface 64; the food chute 68 is located off-center and spans much of the distance between the center of the upper surface 64 and the shoulder 62. The lower end 69 of the food chute 68 extends below the upper surface 64; the lower end 69 of the food chute 68 has a recess 70 adjacent the locator boss 66. Two locking projections 72 with recesses 73 extend upwardly from the upper surface 64 to provide locking locations for the bale lock 36. A tab 74 extends radially outwardly from the shoulder 62 opposite the food chute 68 to facilitate attachments and removal of the lid 26 from the bowl 24.

Referring to FIGS. 3, 7A, 7B and 9, the drive train 28 serves to transfer rotational motion from the motor 30 to various of the blades and accessories of the food processor 20. The drive train 28 includes a bearing 80 that is housed in and is fixed relative to the base 22. Another bearing 82 is mounted above the bearing 80. A drive shaft 84 extends upwardly from the motor 30 through the bearings 80, 82 and is rotatable relative thereto. A blade coupling 86 is fixed to the drive shaft 84. The blade coupling 86 has hex faces 88 that are rotated relative to the drive shaft 84 approximately 30 degrees from top to bottom. A toothed portion 90 of the drive shaft 84 is positioned above the blade coupling 86. A cap 92 fits on the upper end of the drive shaft 84 and is received in the locator boss 66 of the lid 26. The bearings 80, 82 and the cap 92 (held within the locator boss 66) help to keep the drive shaft 84 upright and stable during operation.

A food pusher 250 is shown in FIG. 16. The pusher 250 is generally cylindrical, but has a beveled surface 254 at its lower end 252. Also, the pusher 250 includes a plurality of blades 256 that extend downwardly from the lower end 252. The blades 256 have beveled edges 258. At its upper end, the pusher 250 has a circular flange 260 that is wider (i.e., greater in diameter) than the food chute 68, so that the lower end 252 of the pusher 250 is positioned correctly for the various operations for which it is used.

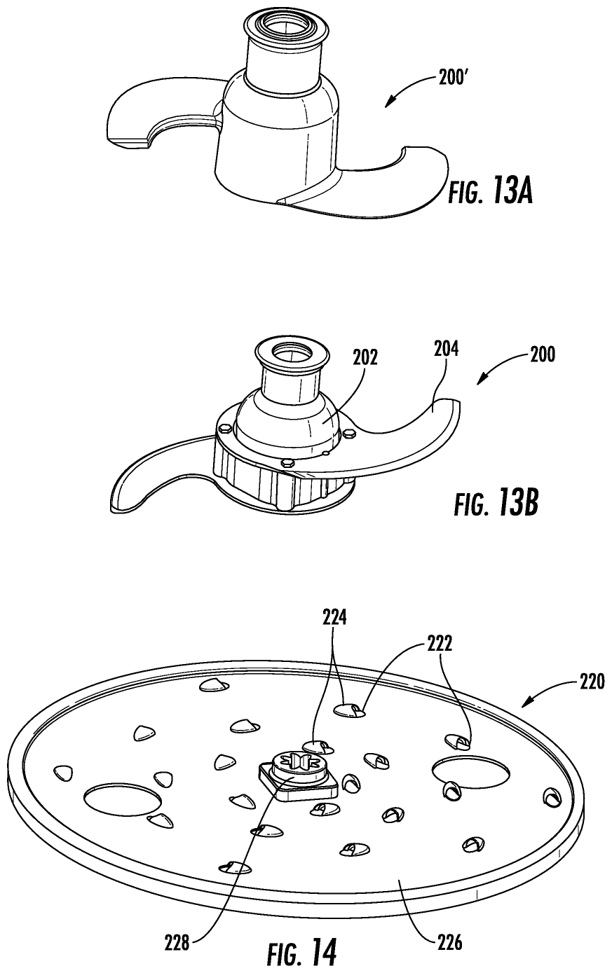

The food processor 20 can utilize multiple blades and accessories. For example, an “S-blade” 200 with a hollow hub 202 and two blades 204 (FIG. 13B) can fit over the drive shaft 84, with an inner “hex” surface of the hub 202 mating with the blade coupling 86. Rotation of the motor 30 drives the drive shaft 84 and, in turn, the S-blade 200. Foodstuffs are introduced into the bowl 24 (either directly, before the lid 26 is attached, or through the food chute 68 via the pusher 230) and can be processed as the S-blade 200 rotates. Typically, the S-blade 200 is employed for chopping, dicing and the like. Alternatively, a “dough blade” 200′ (see FIG. 13A) of generally similar construction, but with thicker blades having blunter edges, can be used for mixing and kneading of bread and pastry dough.

Alternatively, a shredding disk 220 (FIG. 14) may be employed. The shredding disk 220 has shredding holes 222 with sharpened half edges 224 on a main panel 226 that is of sufficient diameter that it spans most, if not all, of the space encircled by the rim 60 of the lid 26. A toothed fitting 228 is located in the center of the main panel 226. The teeth of the fitting 228 are configured to mesh with the teeth of the toothed portion 90 of the drive shaft 84. Once in place, the shredding disk 220 resides at a height generally equally to that of the ridge 48 of the bowl 24. Thus, rotation of the drive shaft 84 rotates the shredding disk 220.

For shredding operations, foodstuffs are introduced into the bowl 24 via the food chute 68. Ordinarily, food is placed in the food chute 68 and, as the shredder disk 220 rotates, forced downwardly with the pusher 250. As it descends, the flange 260 of the pusher 250 eventually contacts the upper edge of the food chute 68 and maintains the lower end 252 of the pusher 250 slightly (typically 1-2 mm) above the shredder disk 220. The food is shredded as it engages the half edges 224 and is forced through the holes 222.

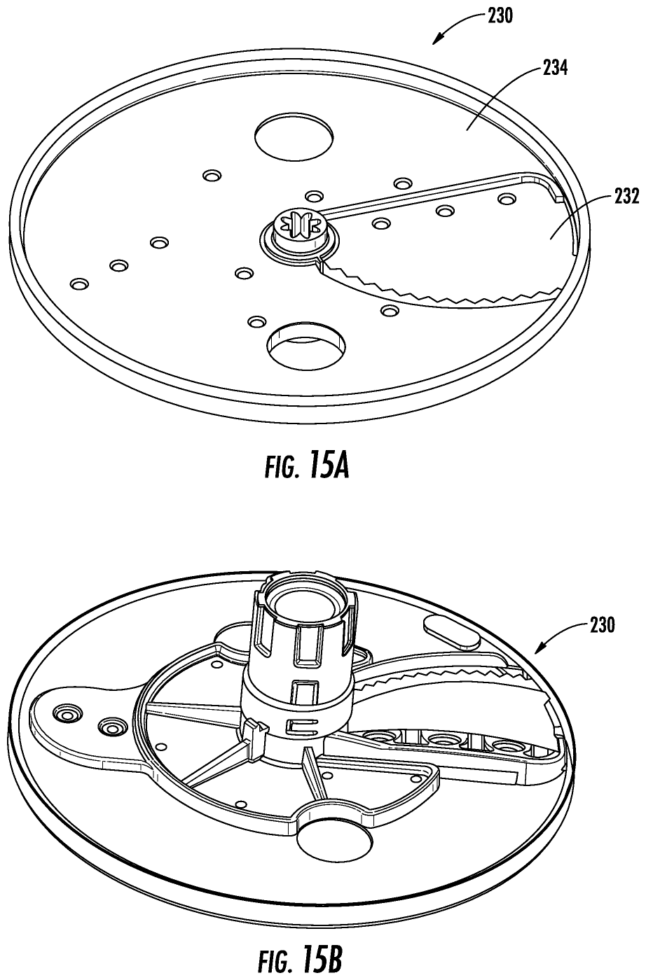

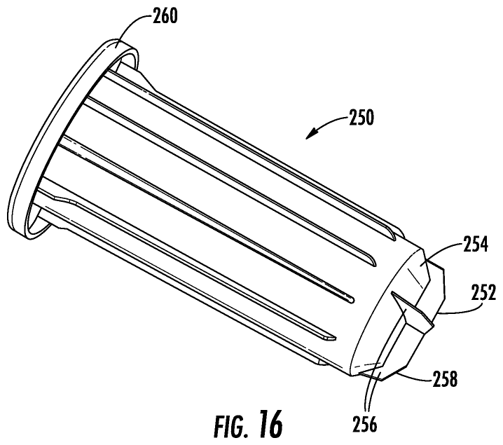

Alternatively, a slicing disk 230 (FIGS. 15A and 15B) can replace the shredder disk 220. The slicing disk 230 is similar to the shredder disk 220 with the exception that the slicing disk 230 has a single blade 232 that extends essentially a full radius of the main panel 234 of the slicing disk 230. The blade 232 is offset slightly above the main panel 234. Rotation of the slicing disk 230 as food is forced through the food chute 68 with the pusher 250 slices the food into separate slices.

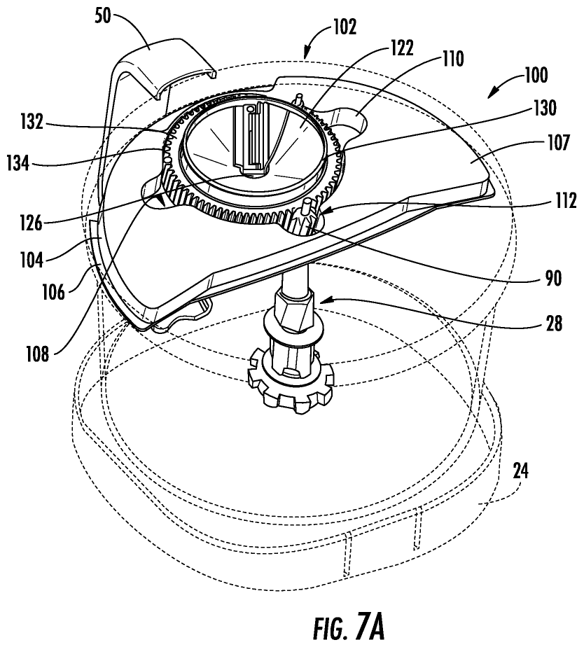

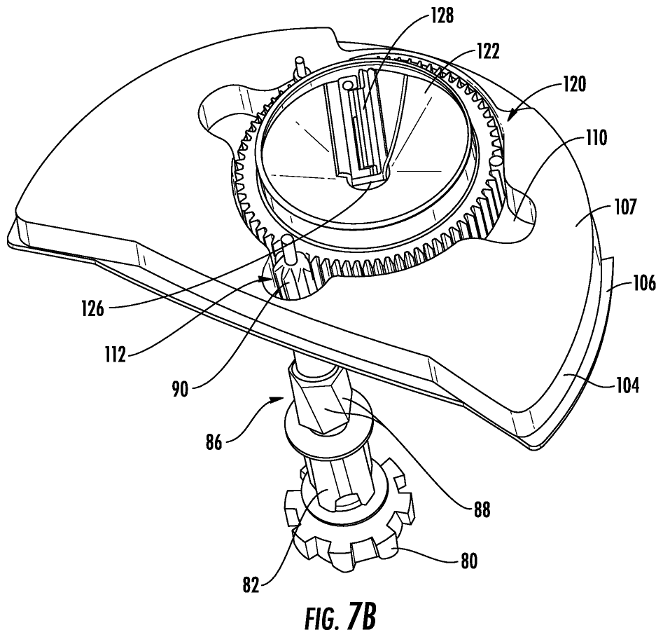

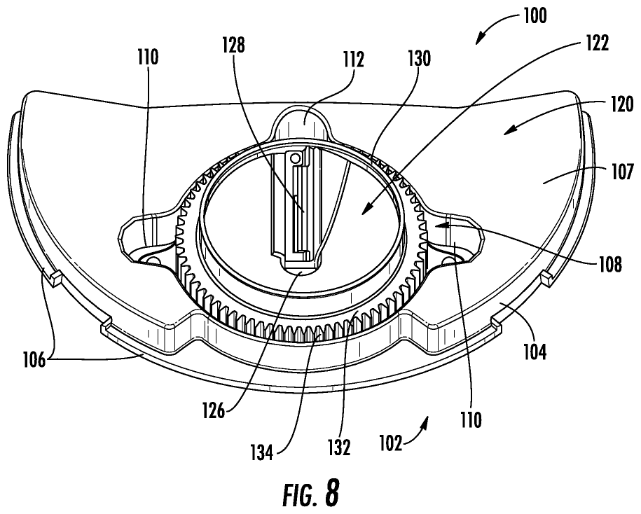

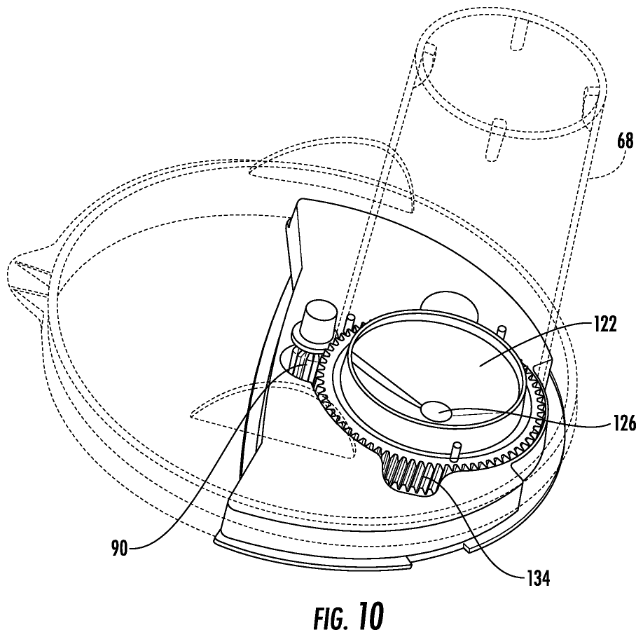

Finally, and as illustrated in FIGS. 7A-12, the food processor 20 may also employ a spiralizer accessory 100. The spiralizer accessory 100 includes a generally semicircular base 102 with a downwardly-depending peripheral edge 104. Three discontinuous ribs 106 extend radially outwardly from the edge 104. A circular recess 108 is present in the upper surface 107 of the base 102. The recess 108 has two pockets 110. An opening 112 is located near the “diameter” of the base 102.

A spiralizer cone 120 resides in the recess 108. The spiralizer cone 120 includes a conical surface 122 that tapers to a narrower end 124 with a hole 126. The conical surface 122 typically defines an angle of between about 25 and 65 degrees relative to vertical (i.e., relative to the axis of rotation of the drive train 28). A blade 128 extends radially from the hole 126 to the edge of the conical surface 122. The conical surface 122 merges at its edges with a circular vertical wall 130. The lower edge of the vertical wall 130 meets a base 132 that extends slightly radially outwardly therefrom. The base has teeth 134 that are sized to mesh with the teeth of the toothed portion 90 of the drive shaft 84, which extends through the opening 112. The spiralizer cone 120 is supported by the base 102 but is free to rotate within the recess 108.

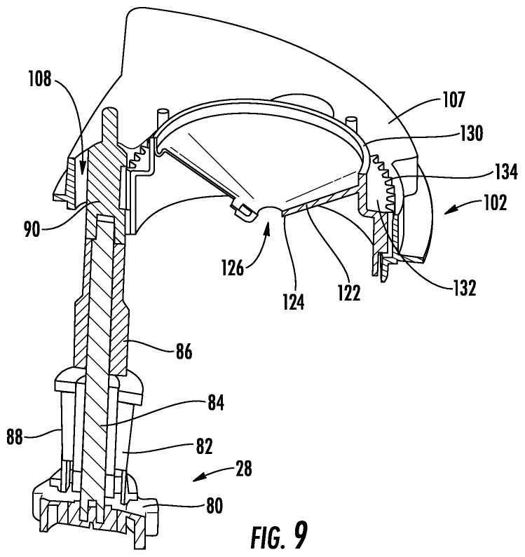

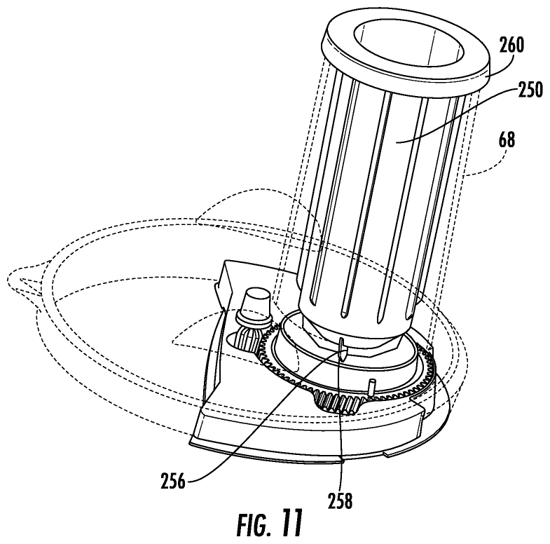

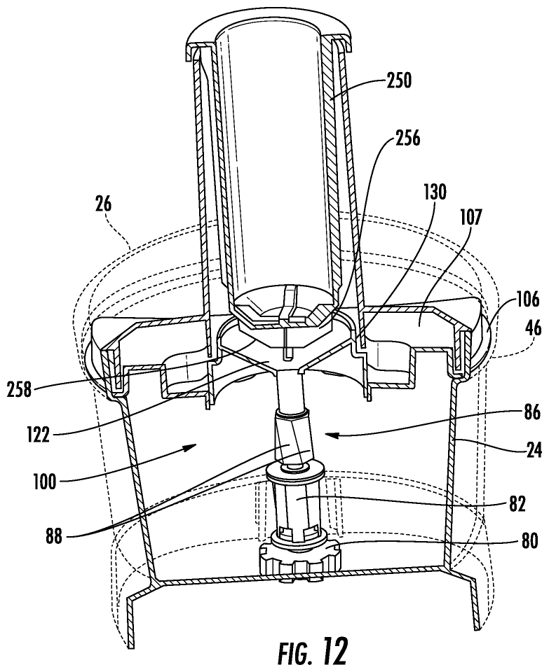

As shown in FIGS. 7A and 9, the spiralizer accessory 100 can be positioned in the bowl 24 for use. The ribs 106 rest atop the lower surface of the lip 46, and are positioned between the nubs 47 to properly orient the base 102. The lid 26 fits over the spiralizer accessory 100, with the rim 60 fitting between the edge 104 of the base 102 and the lip 46 of the bowl 24. Notably, and as seen in FIGS. 9 and 12, the spiralizer accessory 100 is configured such that the conical surface 122 of the spiralizer cone 120 is located largely above the upper surface 107 of the base 102. Also, the upper edge of the vertical wall 130 extends into the lower end of the food chute 68.

The spiralizer assessor 100 is used by first placing food to be spiralized into the food chute 68. The motor 30 is activated, which causes the drive shaft 84 to rotate. Rotation of the toothed portion 90 of the drive shaft 84 rotates the spiralizer cone 120 within the recess 108. The gear ratio of the toothed portion 90 to the spiralizer cone 120 is approximately 8:1, which produces a relative slow angular speed for the spiralizer cone 120. The food is then forced downwardly with the pusher 250 onto the conical surface 122 and the blade 124. Because the speed of the spiralizing cone 120 is relatively slow, the food is able to be spiralized rather than chopped or diced. Notably, the beveled edges 258 of the blades 256 of the pusher 250 are disposed relative to the longitudinal axis of the pusher 250 such that, when the pusher 250 is inserted into the food chute 68, the edges 258 of the blades 256 are substantially parallel to the conical surface 122 of the spiralizer cone 120.

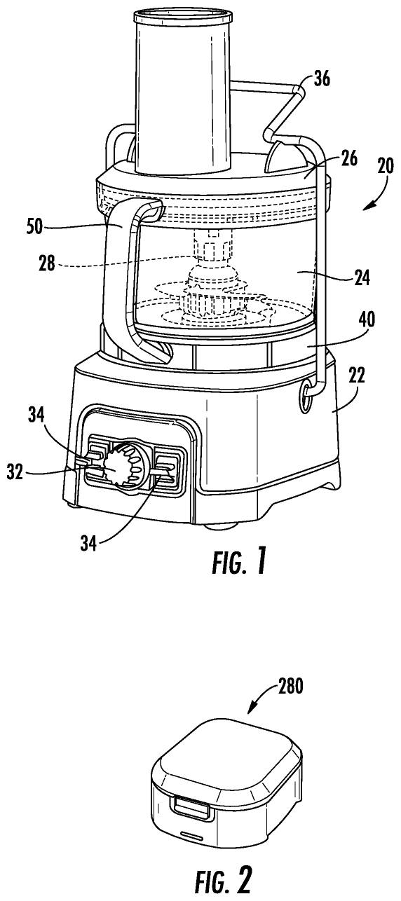

As discussed above and as seen in FIGS. 9 and 12, the spiralizer accessory 100 is configured such that the conical surface 122 of the spiralizer cone 120 is located largely above the upper surface 107 of the base 102, and the upper edge of the vertical wall 130 extends into the lower end of the food chute 68. At this height, the same pusher 250 that is used for shredding and slicing operations can also be used for spiralizing, as it can reach to within a desired distance (typically 1-2 mm) of the conical surface 122 of the spiralizer cone 120. This capability is also enhanced by the presence of the beveled edges 258 of the blades 256, which are substantially parallel to the angle defined by the conical surface 120. The ability of a single pusher 250 to perform all of these tasks means can save the manufacturer the cost of producing two different pushers, and can also save storage space for the consumer (as the pusher 250 is often stored in the food chute 68). As such, a smaller storage case 280 can be used for the spiralizer accessory 100 and the shredder and slicing disks 220. 230 (see FIG. 2).

Those of skill in this art will appreciate that other configurations may also be employed. For example, the spiralizing cone may be a rotary spiralizing member of another form (e.g., the conical surface may be replaced with a rounded tapered surface, a stepped surface, or the like). As another example, the base of the spiralizer accessory may cover the full expanse of the bowl. The elevation of the spiralizer cone and the shredder and slicing disks may vary, with accompanying variation in the length of the pusher. The drive shaft may take a different configuration; for example, the spiralizer accessory may be driven by a friction-producing wheel rather than a toothed gear. The interaction and intermeshing of the edges/rims of the bowl and lid may vary in different embodiments. Other disks, blades and accessories may be included.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A food processor, comprising:
a base having a motor mounted therein;
a container mounted on the base;
a drive train that is coupled to the motor and extends into the container;
a lid that overlies the container, the lid including a generally horizontal upper surface and a food chute that feeds into the container, the food chute extending both above and below the upper surface of the lid; and
a spiralizer accessory, the spiralizer accessory including a base that mounts on the container and a rotary spiralizer member having a spiralizing blade, the spiralizer member residing in a recess in the base and engaging the drive train, such that rotation of the drive train rotates the spiralizer member;
wherein an upper edge of the spiralizer member extends into the food chute.

2. The food processor defined in claim 1, wherein the drive train includes a toothed portion adjacent its upper end, and the spiralizer member includes a plurality of teeth on a peripheral edge thereof that engage the toothed portion of the drive train.

3. The food processor defined in claim 2, wherein an upper edge of the spiralizer member extends above the toothed portion of the drive train.

4. The food processor defined in claim 1, wherein the upper edge of the spiralizer member extends above a generally horizontal upper surface of the base of the spiralizer accessory.

5. The food processor defined in claim 4, wherein the spiralizer member comprises a spiralizer cone with a conical surface.

6. The food processor defined in claim 5, wherein the conical surface extends below the upper surface of the base of the spiralizer accessory.

7. The food processor defined in claim 1, further comprising a food pusher inserted into the food chute, the food pusher including a beveled lower surface.

8. The food processor defined in claim 7, wherein the food pusher further includes blades with beveled edges that extend from the lower surface.

9. A food processor, comprising:
a base having a motor mounted therein;
a container mounted on the base;
a drive train that is coupled to the motor and extends into the container;
a lid that overlies the container, the lid including a generally horizontal upper surface and a food chute that feeds into the container; and
a spiralizer accessory, the spiralizer accessory including a base that mounts on the container and a rotary spiralizer member having a spiralizing blade, the spiralizer member residing in a recess in the base and engaging the drive train, such that rotation of the drive train rotates the spiralizer member;
wherein the drive train includes a toothed portion adjacent its upper end, and the spiralizing member includes a plurality of teeth on a peripheral edge thereof that engage the toothed portion of the drive train; and
wherein an upper edge of the spiralizer member extends above the toothed portion of the drive train.

10. The food processor defined in claim 9, wherein an upper edge of the spiralizer member extends into the food chute.

11. The food processor defined in claim 10, wherein the upper edge of the spiralizer member extends above a generally horizontal upper surface of the base of the spiralizer accessory.

12. The food processor defined in claim 11, wherein a lower edge of the spiralizer member extends below the upper surface of the spiralizer accessory.

13. The food processor defined in claim 12, wherein the spiralizer member comprises a spiralizer cone with a conical surface.

14. The food processor defined in claim 9, further comprising a food pusher inserted into the food chute, the food pusher including a beveled lower surface.

15. The food processor defined in claim 14, wherein the food pusher further includes blades with beveled edges that extend from the lower surface.

16. A food processor, comprising:
a base having a motor mounted therein;
a container mounted on the base;
a drive train that is coupled to the motor and extends into the container;
a lid that overlies the container, the lid including a generally horizontal upper surface and a food chute that feeds into the container; and
a spiralizer accessory, the spiralizer accessory including a base with a horizontal upper surface that mounts on the container and a spiralizer cone having a conical surface and a spiralizing blade, the spiralizer cone residing in a recess in the horizontal surface of the base and engaging the drive train, such that rotation of the drive train rotates the spiralizer cone;
wherein an upper edge of the spiralizer cone extends above the upper surface of the spiralizer accessory base and a lowermost end of the spiralizer cone extends below the upper surface of the spiralizer accessory base.

17. The food processor defined in claim 16, wherein an upper edge of the spiralizer cone extends into the food chute.

18. The food processor defined in claim 16, wherein the conical surface defines an angle of between about 25 and 65 degrees relative to an axis of rotation defined by the drive train.

19. The food processor defined in claim 16, further comprising a food pusher inserted into the food chute, the food pusher including a beveled lower surface.

20. The food processor defined in claim 19, wherein the food pusher further includes blades with beveled edges that extend from the lower surface.
